(19) United States
(12) Patent Application Publication
(10) Pub. No.: US 2025/0233395 A1
(43) Pub. Date: Jul. 17, 2025

(54) CABLE HANGER ASSEMBLY WITH SEPERABLE SUPPORT

(71) Applicant: Gamechange Solar Corp., Norwalk, CT (US)

(72) Inventors: Andrew Barron Worden, Redding, CT (US); Woo Kim, Little Neck, NY (US); David Peck, Danbury, CT (US); Claude Colp, Hingham, MA (US)

(73) Assignee: Gamechange Solar Corp., Norwalk, CT (US)

(21) Appl. No.: 18/106,895

(22) Filed: Feb. 7, 2023

(51) Int. Cl. H02G 3/00; H02G 3/04; H02S 40/34

(52) U.S. Cl. CPC H02G 3/263; H02G 3/0456; H02S 40/34

(57) ABSTRACT

A cable hanger assembly comprises a frame including a base that comprises a first base surface and a second base surface separated by a channel open at a proximate channel end and closed at a distal channel end, where the channel is formed by a first channel support extending from the proximate end and a second channel support extending from the proximate end; a first support extending from a distal end of the first base surface; a second support extending from a distal end of the second base surface. A hanger support extends along the first base surface, the first channel support, the second channel support and the second base surface and attaches to the frame, and includes a radiused hanger surface at a distal end of the channel. The first channel support, the first base surface and the first support form a first cable receptacle area.

### BACKGROUND OF THE INVENTION

### 1. Technical Field

This disclosure relates generally to cable hangers, and in particular to a cable hanger assembly that includes a separable support for use with solar panel mounting systems.

### 2. Background Information

Cable hangers are known for suspending cables (e.g., power and data) from a messenger wire or other support. As utility scale solar plants have increased in scope there is a greater need to handling the increased number of cables that are suspended from the racking or tracker systems. There is a need for improved cable hangers, for example, for use in a system that includes an array of solar panels, for improved cable management.

### SUMMARY OF THE DISCLOSURE

According to an aspect of the disclosure, a cable hanger assembly comprises a frame and a hanger support. The frame comprises a base that includes a first base surface and a second base surface separated by a channel open at a proximate channel end and closed at a distal channel end, where the channel is formed by a first channel support extending from the proximate end and a second channel support extending from the proximate end; and a first support extending from a distal end of the first base surface; a second support extending from a distal end of the second base surface. The hanger support extends along the first base surface, the first channel support, the second channel support and the second base surface and attaches to the frame, and includes a radiused hanger surface at a distal end of the channel. The first channel support, the first base surface and the first support form a first cable receptacle area.

The first sidewall support may comprise a truss structure with a plurality of ribs.

The hanger support may removably and replaceably attach to the unitary skeletal frame.

The hanger may support the first base surface, the first channel sidewall, the second channel sidewall and the second base surface.

The unitary skeletal frame may comprise plastic.

The hanger support may be metallic.

The first sidewall support may extend substantially parallel with respect to the second sidewall support.

The first sidewall support may extend substantially parallel with respect to the channel.

The first channel support may comprise a truss structure comprising a first channel support interior sidewall and a first channel support exterior sidewall, the second channel sidewall support comprises a truss structure comprising a second channel support interior sidewall and a second channel support exterior sidewall, where the first and second interior sidewalls are opposing and form the channel.

The first support may comprise a truss structure comprising a first support interior sidewall and a first support exterior sidewall, the second support comprises a truss structure comprising a second support interior sidewall and a second support exterior sidewall.

The second channel support, the second base surface and the second support form a second cable receptacle area.

A first finger may extend from the distal end of the first support towards the distal end of the channel.

The cable hanger assembly may comprise a second finger that extends from the distal end of the second support towards the distal end of the channel.

The cable hanger assembly may comprise at least one of a first J-hook truss structure extending from a distal end of the first support, where the first J-hook truss structure and the first finger form a third cable receptacle area.

The cable hanger assembly may comprise a second J-hook truss structure extending from a distal end of the second support, where the second J-hook truss structure and the second finger form a fourth cable receptacle area.

The distal end of the first finger may comprise a first slot nut and the first channel support exterior sidewall includes a slot that removably receives the first slot nut.

The first and second channel support interior sidewalls may be separated at the distal end by radiused edge of the frame.

The first finger may comprise an outwardly facing furcated member.

The hanger support may be snap-fit to the frame at a plurality of locations along the first base surface, the first channel sidewall, the second channel sidewall and the second base surface, where the frame is skeletal.

The hanger support may be a unitary structure.

According to another aspect of the disclosure, a cable hanger assembly comprises a unitary skeletal frame and a hanger support. The a unitary skeletal frame includes a base having a base interior surface and a base exterior surface; a first exterior support extending from the base and having a first exterior support interior surface and a first exterior support exterior surface; a second exterior support extending from the base and having a second exterior support interior surface and a second exterior support exterior surface; an interior support extending from the base between the first and second exterior supports; and a plurality of furcated members on the first exterior support interior surface, on the second exterior support interior surface and on the interior support. The hanger support attaches along the base exterior surface, the first exterior support exterior surface and the second exterior support exterior surface to support the unitary skeletal frame.

The base, the first exterior support and the second exterior support may each comprise a truss structure with a plurality of ribs.

The hanger support may comprise a first hook at a first end of the hanger support attached to the unitary skeletal frame adjacent to a distal end of the first exterior support, and a second hook at a second end of the hanger support attached to the unitary skeletal frame adjacent to a distal end of the second exterior support.

The hanger support may be metallic.

The hanger support may be snap-fit to the unitary skeletal frame along the base exterior surface, the first exterior support exterior surface and the second exterior support exterior surface.

The unitary skeletal frame may be a plastic component.

The foregoing features and the operation of the invention will become more apparent in light of the following description and the accompanying drawings.

### BRIEF DESCRIPTION OF THE DRAWINGS

FIG. 1 illustrates a front view of a cable hanger assembly that includes a frame and a hanger support;

FIG. 2 illustrates a perspective view of the cable hanger assembly illustrated in FIG. 1;

FIG. 3 is a front view of the hanger support that may be engaged to the frame illustrated in FIGS. 1 and 2;

FIG. 4 is a cross-sectional view of the hanger support taken along line 4-4 in FIG. 3;

FIG. 5 is a detailed view of area J of the hanger support shown in FIG. 4;

FIG. 6 is a front view of the frame;

FIG. 7 is a cross sectional view of the frame taken along line 7-7 in FIG. 6;

FIG. 8 is a detailed view of a first channel support interior sidewall illustrating a projection for attaching of the hanger support and flow diverters;

FIG. 9 is a perspective bottom view of a portion of the underside of the frame base;

FIG. 10 illustrates an exploded view of the cable hanger assembly comprising the frame and the cable support;

FIG. 11 illustrates a perspective view of an alternative embodiment frame for a cable hanger assembly;

FIG. 12 is an exploded view of an alternative embodiment cable hanger assembly that includes the alternative embodiment frame of FIG. 11 and an alternative embodiment hanger support; and

FIG. 13 is a perspective of the alternative embodiment cable hanger assembly that includes the alternative embodiment frame and the alternative embodiment hanger support illustrated in FIG. 12.

### DETAILED DESCRIPTION

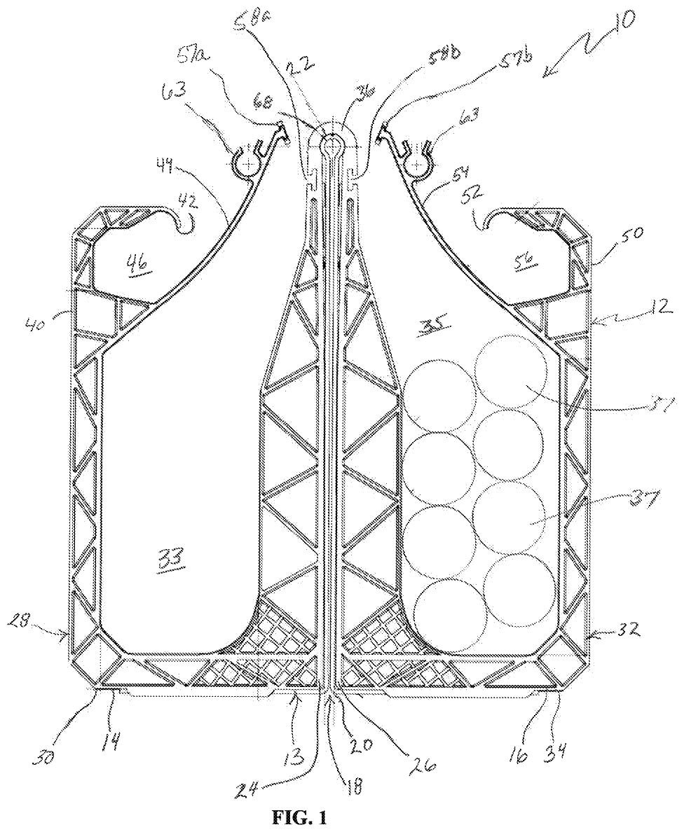

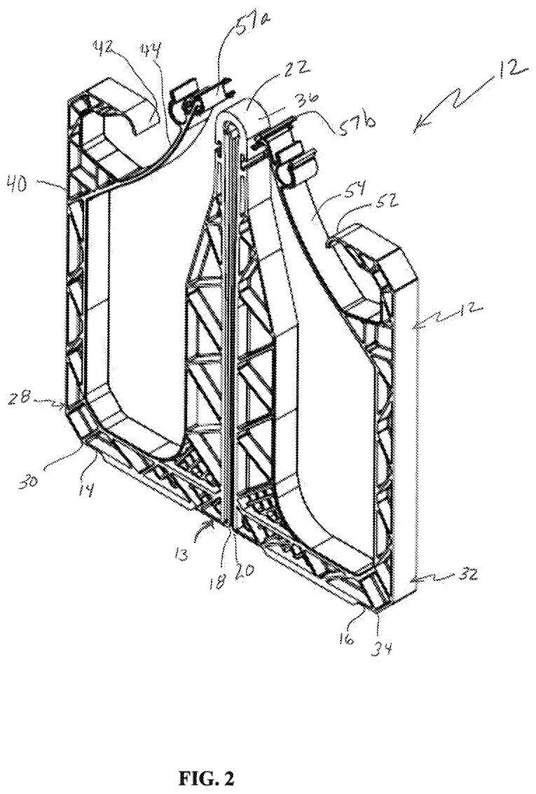

FIG. 1 illustrates a front view of a cable hanger assembly 10 that includes a frame 12 and a hanger support 13. FIG. 2 illustrates a perspective view of the frame 12 illustrated in FIG. 1. Referring to FIGS. 1 and 2, the frame 12 includes a base that comprises a first base surface 14 and a second base surface 16, which are separated by a channel 18 that is open at a proximate channel end 20 and closed at a distal channel end 22. The channel 18 is formed by a first channel support 24 extending from a proximate end of the first base surface 14 and an opposing second channel support 26 extending from a proximate end of the second base surface 16. The first and second channel supports 24, 26 are in opposing spaced relationship to form the channel 18.

A first support 28 extends from a distal end 30 of the first base surface 14. The first support 28 may extend substantially parallel with respect to the channel 18. A second support 32 extends from a distal end 34 of the second base surface 16. In the case of the first and second supports 28, 32 the terms “proximate” and “distal” are with respect to the channel 18. In one embodiment the first and second supports 28, 32 may extend substantially parallel with respect to the channel 18.

A first cable receptable area 33 (e.g., U-shaped) is formed by the first channel support 24, the first base surface 14 and the first support 28. A second cable receptable area 35 is formed by the second 26, the second base surface 16 and the second support 32. For illustrative purposes a plurality of cables 37 are shown in the second cable receptable area 35.

The frame 12 may be configured as a skeletal frame as a truss with a plurality of webs forming at least a portion of (i) the first and second bases 14, 16, (iii) the first and second channel supports 24, 26 and (iii) the first and second supports 28, 32. It is contemplated that the frame 12 may also be a solid. In addition, the frame 12 is preferably a unitary (i.e., single piece) structure, but it is contemplated that the frame may be a multi-piece assemblage comprising one or more materials. The frame may be a plastic, such as for example polypropylene with a UV additive.

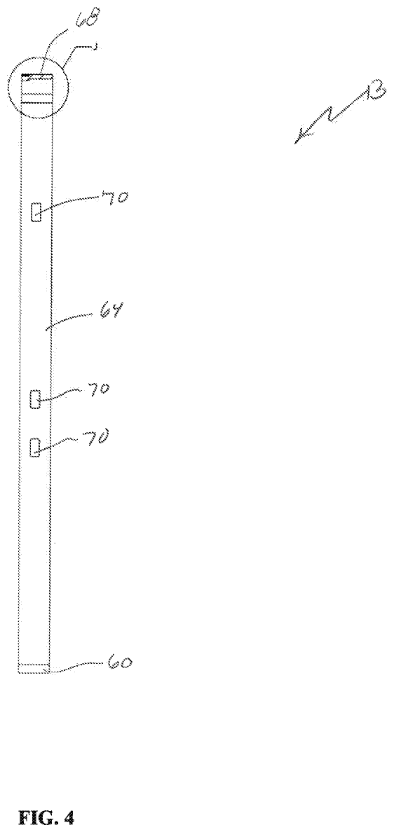

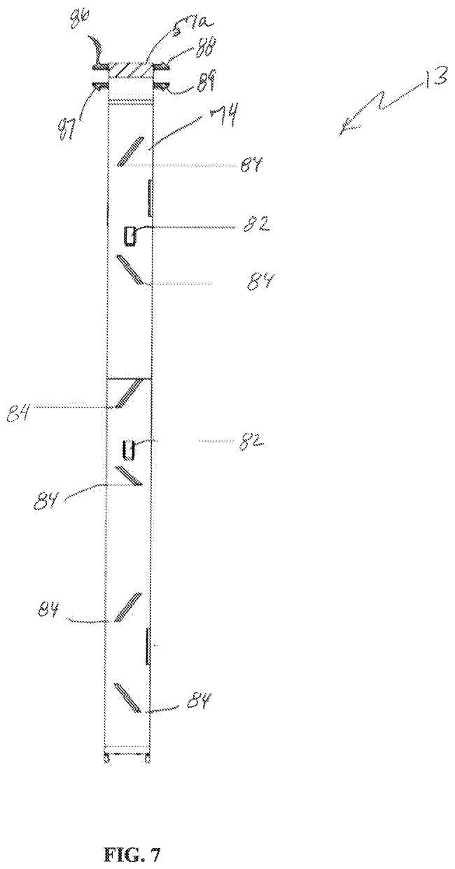

Referring still to FIGS. 1 and 2, the cable hanger assembly 10 also includes the hanger support 13 that extends along the first base surface 14, the first channel support 24, a radiused segmented 36 at the distal end 22 of the channel 18, the second channel support 26 and the second base surface 16. The hanger support 13 attaches to the frame 12, such as for example via a plurality of snap-fits. It is contemplated that the hanger support 13 may attach to the frame any number of different ways (e.g., a via fasteners) such that the hanger support 13 adds structural rigidity to the frame 12. Attachment of the hanger support 13 to the frame shall be discussed below with respect to FIGS. 4 and 7.

The first support 28 comprises a first finger projection 40 that includes a first finger distal end 42, which is separated from a first flexible arm 44 to form a third cable receptacle area 46 in cooperation with the first finger projection 40. The first finger projection 40 may be L- or J-shaped, but it is contemplated that the first finger projection 40 may take on various shapes to form a suitable cable receptacle area with the first flexible arm 44.

The second support 32 comprises a second finger projection 50 that includes a second finger distal end 52. The finger distal end 52 is separated from a second flexible arm 54 to form a fourth cable receptacle area 56 in cooperation with the second finger projection 50. Similar to the first finger projection 40, the second finger projection 50 may be L- or J-shaped, but it is contemplated that the finger projection may take on various shapes to form a suitable cable receptacle area with the second flexible arm 54.

Referring still to FIGS. 1 and 2, the distal end of the first finger 44 comprises a first slot nut 57a (e.g., a key) and the first channel support 24 includes a slot 58a that removably receives the first slot nut 57a. This closes the first cable receptable area 33. Similarly on the opposite side, the distal end of the second finger 54 comprises a second slot nut 57b and the second channel support 26 includes a slot 58b that removably receives the second slot nut 57b. This closes the second cable receptable area 35. The first and second fingers 44, 54 may also include a furcated member 63.

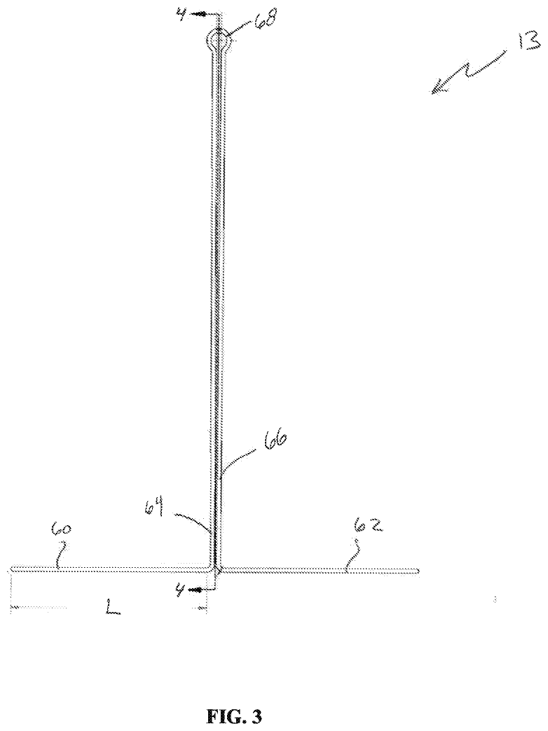

FIG. 3 is a front view of the hanger support 13, that may be engaged to the frame 12 illustrated in FIGS. 1 and 2. The hanger support is symmetrical about a line 4-4 and includes a first frame support surface 60 and a second frame support surface 62, each having a length L and a width W. The hanger support also includes first and second support legs 64, 66 that extend from an associated one of frame support surfaces 60, 62 and at a distal end form a radiused hanger surface 68. The radiused hanger surface 68 is sized to support the cable hanger assembly from a wire (e.g., a messenger wire, a ground wire, a multi-function line, etc.). The first and second frame support surfaces 60, 62 may be planar. The hanger support 13 is preferably metallic (e.g., galvanized steel) for strength and formed as a unitary component.

The frame 12 (FIGS. 1 and 2) alone (i.e., without the hanger support) may operate as a cable hanger. However, to increase the structural integrity of the frame, the hanger support 13 may be added to the frame to form the cable hanger assembly 10 (FIGS. 1 and 2). This allows the frame 12 to support the load from more cables in the cable receptacle areas.

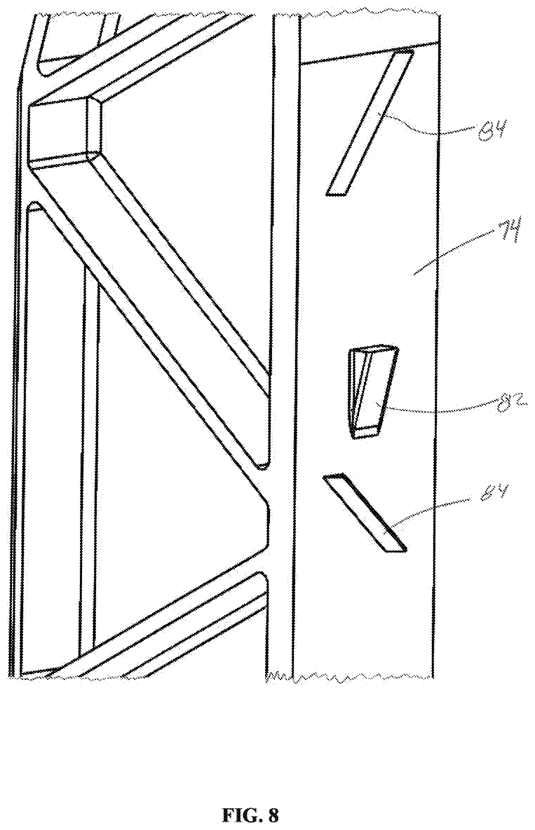

FIG. 4 is a cross-sectional view of the hanger support 13 taken along line 4-4 in FIG. 3. To attach the hanger support 13 to the frame 12, the first support leg 64 includes a plurality of openings 70, which engage with projections on the first channel support 24 (FIG. 1) to attach the frame 12 to the hanger support 13 (e.g., via a snap fit, a friction fit, et cetera). The projections shall be discussed herein below with respect to FIGS. 7 and 8. Referring still to FIG. 4, the second hanger support leg 62 includes a plurality of openings that engage with projections on the second channel support 26 in order to attach the hanger support 13 to the frame.

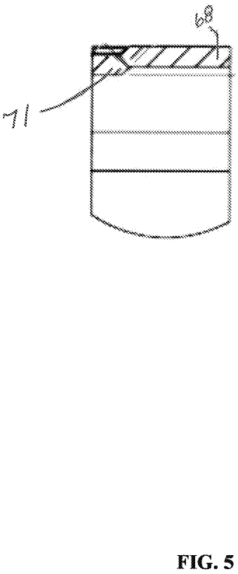

FIG. 5 is a detailed view of area J of the hanger support 13 shown in FIG. 4. The radiused hanger surface 68 includes a serrated edge 71 that bites into the wire (e.g., a messenger wire, a ground wire, a multi-function line, etc.) that the radiused hanger surface 68 is hung from. The serrated edge(s) 71 preferably bends down slightly to bite into the wire (not shown). This reduces longitudinal movement of the radiused hanger surface 68 along the length of the wire and helps to retain the desired spacing between hangers.

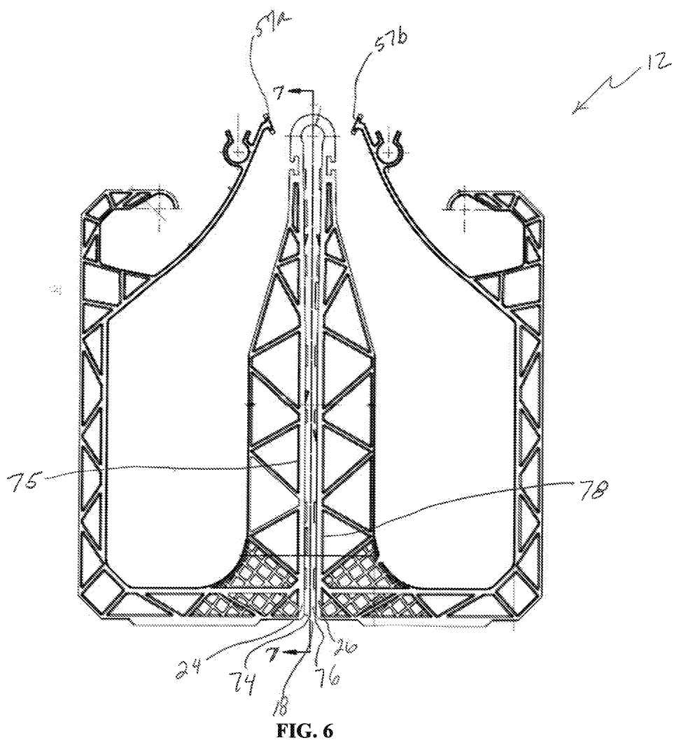

FIG. 6 is a front view of the frame 12 without the hanger support 13 attached thereto. The first channel support 24 comprises a truss structure that includes a first channel support interior sidewall surface 74 and a first channel support exterior sidewall surface 75. The second channel support also 26 also comprises a truss structure that includes a second channel support interior sidewall 76 and a second channel support exterior sidewall 78. The first and second channel support interior sidewall surfaces 74, 76 are opposing and form the channel 18.

FIG. 7 is a cross sectional view of the frame 12 taken along line 7-7 in FIG. 6. Each of the first and second channel support interior sidewall surfaces 74, 76 includes a plurality of projections 82. The projections 82 are sized and shaped to provide a snap-fit or a friction fit with the plurality of the openings 70 in the first and second legs 64, 66 of the hanger support 13 (FIG. 3) in order to attach the hanger support to the frame. At least one of the first and second channel support interior sidewall surfaces 74, 76 also includes a plurality of flow diverters 84 to disrupt the flow of rainwater that may move down the sidewall surfaces 74, 76 that form the channel 18. The flow diverters 84 may be angled/sloped as shown in FIG. 7 to control the flow of water along the surface of the channel support sidewall. The first slot nut 57a includes a front pair of flexible tabs 86, 87 and a rear pair of flexible tabs 88, 89. Similarly, the second slot nut 57b (see FIG. 1) includes front and rear flexible tabs. The first and second slot nuts 57a, 57b include the flexible tabs to secure the tab in the associated slot.

The slot nuts 57a, 57b are inserted into their respective slots 58a, 58b by pushing the rear pair of flexible tabs into and through the respective slot 50. The nut cannot be pushed entirely through the slot because abutment surfaces of the front pair of flexible tabs limit the travel of the slot nut within the slot. When the nut is pushed far enough into the slot, the rear pair of flexible tabs are then outside the slot and the rear tabs flex slightly outwardly so the rear tabs cannot pass back through the slot without the rear tabs being pinched inward enough so the rear tabs can enter the slot. This provides a relatively easy and quick way to close first cable receptable area 33 (FIG. 1) to ensure cables remain in place.

FIG. 8 is a detailed view of the first channel support interior sidewall surface 74 illustrating the projection 82 for attaching of the hanger support to the frame, and the flow diverters 84.

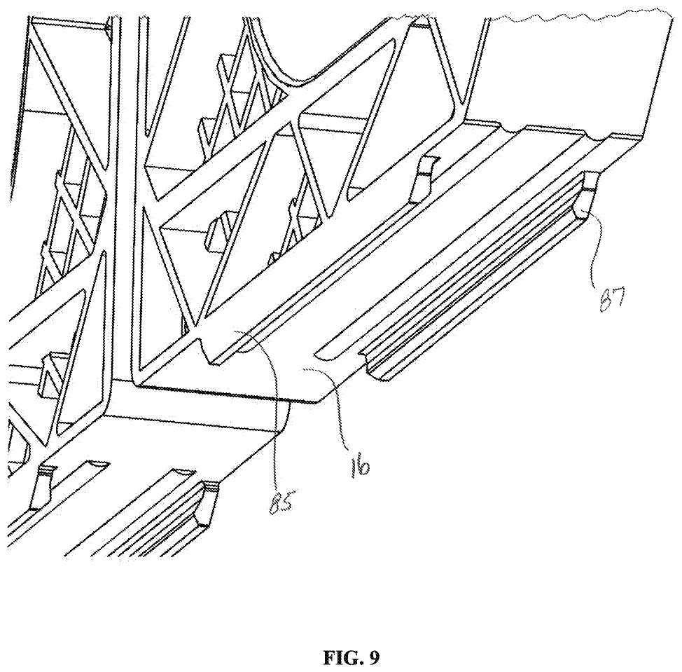

FIG. 9 is a perspective bottom view of a portion of the underside of the second base surface 16 of the frame 12 (FIG. 6). The second base surface 16 includes opposing first and second parallel rails 85, 87 that are spaced to accept frame support surfaces 60, 62 (FIG. 3) of the hanger support 13 (FIG. 2). The interior opposing surfaces of the rails are shaped to allow the frame support surfaces to be snapped into the rails thus positioning the hanger support 13 to support the frame along its first and second base surfaces 14, 16.

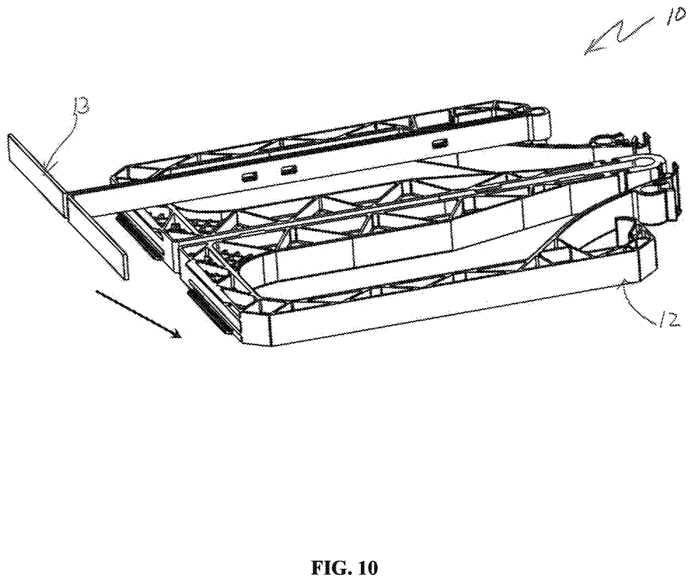

FIG. 10 is an exploded view of cable hanger assembly comprising the frame 12 and the hanger support 13. In this embodiment, to attach the hanger support 13 to the frame 12 the hanger support is positioned as shown in FIG. 10 and then pushed down into the channel 18 and upward towards the distal end 22 of the channel 18. This allows the openings 70 of the support to align with the associated projections 82 in the frame 12 to attach the support to the frame. In an alternative embodiment it is contemplated that the frame may have the openings and the support would have the supporting openings.

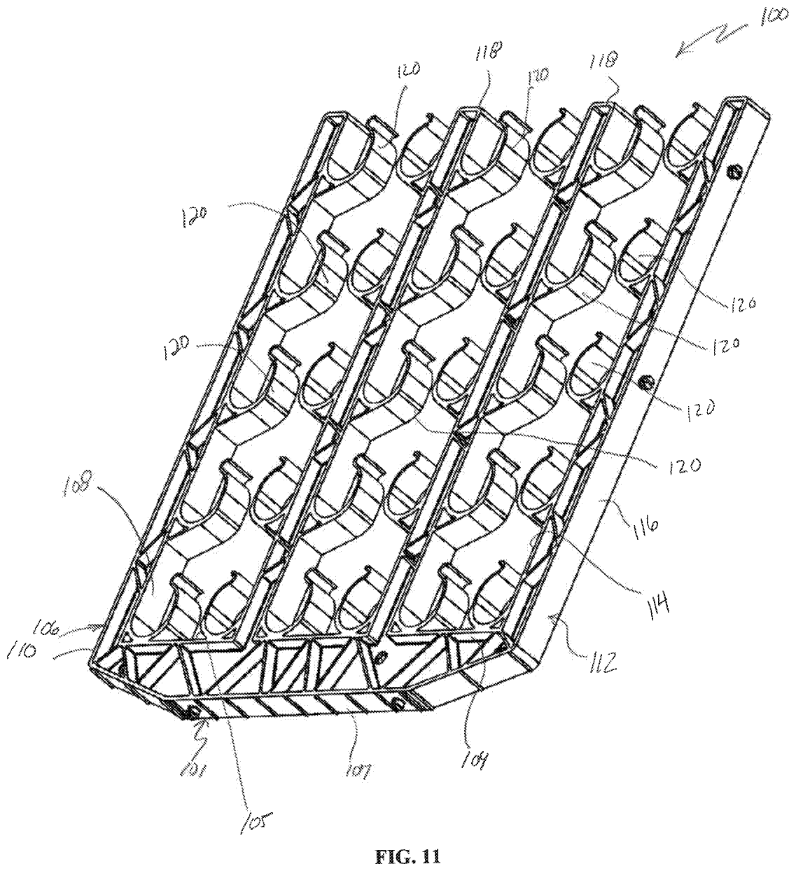

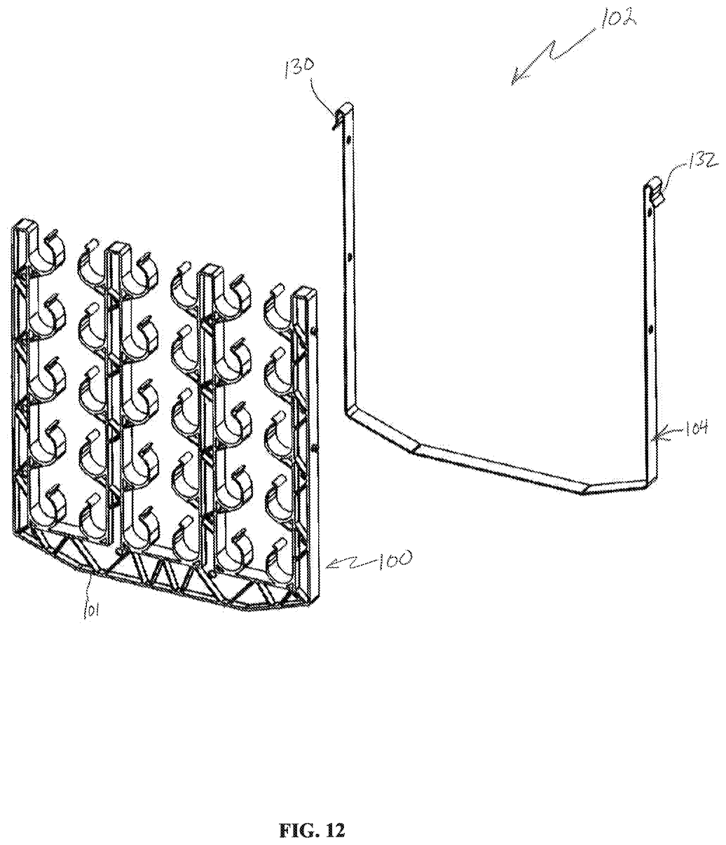

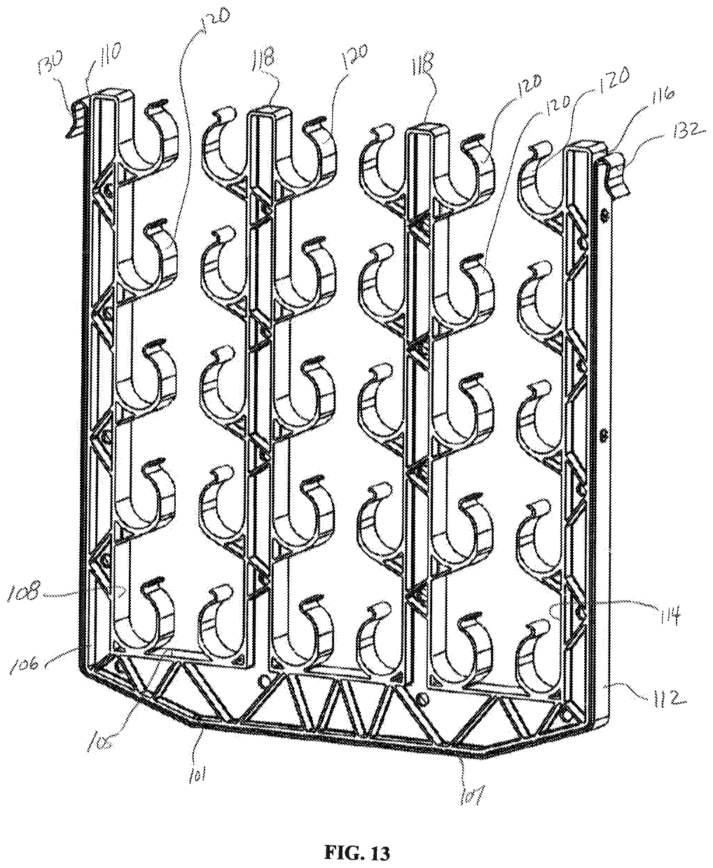

FIG. 11 illustrates a perspective view of an alternative embodiment frame 100 for a cable hanger assembly. FIG. 12 is an exploded view of an alternative embodiment cable hanger assembly 102 that includes the alternative embodiment frame 100 of FIG. 10 and an alternative embodiment hanger support 104. FIG. 13 is a perspective of the alternative embodiment cable hanger assembly 102 that includes the alternative embodiment frame 100 and the alternative embodiment hanger support 100 illustrated in FIG. 12.

Referring to FIGS. 11-13, the frame 100 comprises a base 101 having a base interior surface 105 and a base exterior surface 107. A first exterior support 106 extends from the base 101 and has a first exterior support interior surface 108 and a first exterior support exterior surface 110. A second exterior support 112 extends from the base and includes a second exterior support interior surface 114 and a second exterior support exterior surface 116. One or more interior supports 118 extends from the base interior surface 105 between the first and second exterior supports 106, 112. A plurality of furcated members 120 are located on the interior surface 108, on the interior surface 114 and the interior surfaces 118. As shown in FIGS. 12 and 13, a hanger support 104 attaches along the base exterior surface 107, the first exterior support exterior surface 110 and the second exterior support exterior surface 116 to support the unitary skeletal frame 100. The hanger support 104 may be secured to the frame 100 using projections, such as for example mushroom head fasteners.

Referring to FIGS. 11-13, the base 101, the first exterior support 106 and the second exterior support 112 each comprise a truss structure with a plurality of ribs. However, it is contemplated that any of these may be solid rather than arranged as a truss structure. The frame may be a unitary structure arranged as a skeletal frame.

The hanger support 104 comprises a first hook 130 at a first sidewall end of the hanger support and a second hook 132 at a second sidewall end. The hanger support may be metallic (e.g., galvanized spring steel) or non-metallic (e.g., plastic).

The hanger support 104 may be snap-fit to the frame 100 along one or more of the base exterior surface 101, the first exterior support exterior surface 110 and the second exterior support exterior surface 116. The frame 100 may also include a plurality of through holes 134 that may be used with zip ties (not shown) to secure cables within the furcated members 120. It is contemplated, some or all of the base may be solid rather than skeletal.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A cable hanger assembly, comprising:
a frame comprising
a base that comprises a first base surface and a second base surface separated by a channel open at a proximate channel end and closed at a distal channel end, where the channel is formed by a first channel support extending from the proximate end and a second channel support extending from the proximate end;
a first support extending from a distal end of the first base surface;
a second support extending from a distal end of the second base surface; and
a hanger support that extends along the first base surface, the first channel support, the second channel support and the second base surface and attaches to the frame, and includes a radiused hanger surface at a distal end of the channel,
where the first channel support, the first base surface and the first support form a first cable receptacle area.

2. The cable hanger assembly of claim 1, where the first sidewall support comprises a truss structure with a plurality of ribs.

3. The cable hanger assembly of claim 1, where the hanger support removably and replaceably attaches to the unitary skeletal frame.

4. The cable hanger assembly of claim 3, where the hanger supports the first base surface, the first channel sidewall, the second channel sidewall and the second base surface.

5. The cable hanger assembly of claim 4, where the unitary skeletal frame comprises plastic.

6. The cable hanger assembly of claim 5, where the hanger support is metallic.

7. The cable hanger assembly of claim 5, where first sidewall support extends substantially parallel with respect to the second sidewall support.

8. The cable hanger assembly of claim 5, where first sidewall support extends substantially parallel with respect to the channel.

9. The cable hanger assembly of claim 5, where the first channel support comprises a truss structure comprising a first channel support interior sidewall and a first channel support exterior sidewall, the second channel sidewall support comprises a truss structure comprising a second channel support interior sidewall and a second channel support exterior sidewall, where the first and second interior sidewalls are opposing and form the channel.

10. The cable hanger assembly of claim 5, where the first support comprises a truss structure comprising a first support interior sidewall and a first support exterior sidewall, the second support comprises a truss structure comprising a second support interior sidewall and a second support exterior sidewall.

11. The cable hanger assembly of claim 1, where the second channel support, the second base surface and the second support form a second cable receptacle area.

12. The cable hanger assembly of claim 10, further comprising a first finger that extends from the distal end of the first support towards the distal end of the channel.

13. The cable hanger assembly of claim 12, further comprising a second finger that extends from the distal end of the second support towards the distal end of the channel.

14. The cable hanger assembly of claim 13, further comprising at least one of a first J-hook truss structure extending from a distal end of the first support, where the first J-hook truss structure and the first finger form a third cable receptacle area.

15. The cable hanger assembly of claim 14, further comprising a second J-hook truss structure extending from a distal end of the second support, where the second J-hook truss structure and the second finger form a fourth cable receptacle area.

16. The cable hanger assembly of claim 14, where the distal end of the first finger comprises a first slot nut and the first channel support exterior sidewall includes a slot that removably receives the first slot nut.

17. The cable hanger assembly of claim 14, where the first and second channel support interior sidewalls are separated at the distal end by radiused edge of the frame.

18. The cable hanger assembly of claim 17, where the first finger comprises an outwardly facing furcated member.

19. The cable hanger assembly of claim 1, where the hanger support is snap-fit to the frame at a plurality of locations along the first base surface, the first channel sidewall, the second channel sidewall and the second base surface, where the frame is skeletal.

20. The cable hanger assembly of claim 19, where hanger support is a unitary structure.

21. A cable hanger assembly, comprising:
a unitary skeletal frame comprising
a base having a base interior surface and a base exterior surface;
a first exterior support extending from the base and having a first exterior support interior surface and a first exterior support exterior surface;
a second exterior support extending from the base and having a second exterior support interior surface and a second exterior support exterior surface;
an interior support extending from the base between the first and second exterior supports;
a plurality of furcated members on the first exterior support interior surface, on the second exterior support interior surface and on the interior support; and
a hanger support that attaches along the base exterior surface, the first exterior support exterior surface and the second exterior support exterior surface to support the unitary skeletal frame.

22. The cable hanger assembly of claim 21, where the base, the first exterior support and the second exterior support each comprise a truss structure with a plurality of ribs.

23. The cable hanger assembly of claim 22, where hanger support comprises:
a first hook at a first end of the hanger support attached to the unitary skeletal frame adjacent to a distal end of the first exterior support; and
a second hook at a second end of the hanger support attached to the unitary skeletal frame adjacent to a distal end of the second exterior support.

24. The cable hanger assembly of claim 23, where the hanger support is metallic.

25. The cable hanger assembly of claim 21, where the hanger support is snap-fit to the unitary skeletal frame along the base exterior surface, the first exterior support exterior surface and the second exterior support exterior surface.

26. The cable hanger assembly of claim 25, where the unitary skeletal frame is a plastic component.
